(19) United States
(12) Patent Application Publication
(10) Pub. No.: US 2006/0000358 A1
(43) Pub. Date: Jan. 5, 2006

(54) Purification and delivery of high-pressure fluids in processing applications

(76) Inventors: Rajat Agrawal, Naperville, IL (US); Ikuo Hirase, Plano, TX (US); James J.F. McAndrew, Homer Glen, IL (US); Joseph E. Paganessi, Burr Ridge, IL (US)

Correspondence Address: Linda K. Russell;Patent Counsel, Air Liquide, 2700 Post Oak Blvd., Suite 1800, Houston, TX, 77056, US

(21) Appl. No.: 11/145,190

(22) Filed: Jun. 6, 2005

Related U.S. Application Data
(60) Provisional application No. 60/583,714, filed on Jun. 29, 2004.

(51) Int. Cl. B01D 46/00

(52) U.S. Cl. 95/273

(57) ABSTRACT

A purification and delivery system delivers a high-pressure fluid (e.g., carbon dioxide) to a process area and includes a fluid supply tank with a fluid in a liquid state. A purification section is provided in the system and includes at least one purification unit to remove at least one component from the fluid, and a high-pressure pump is disposed downstream from the fluid supply tank and proximate the process area. The high-pressure pump pressurizes the fluid to a process pressure that is greater than the pressure of the fluid within the fluid supply tank. By providing the high-pressure pump proximate the process area, the distance at which high-pressure fluid must be transported while maintaining required operating temperatures and pressures is minimized.

### CROSS-REFERENCE TO RELATED APPLICATION

This application claims priority from U.S. Provisional Patent Application Ser. No. 60/583,714, entitled “High-Pressure Delivery System”, and filed Jun. 29, 2004. The disclosure of this provisional patent application is incorporated herein by reference in its entirety.

### BACKGROUND OF INVENTION

1. Field of Invention

The present invention pertains to pressurizing and delivering fluids, in particular carbon dioxide, to processing systems at sufficiently high pressures and purity levels.

2. Related Art

Many applications are emerging in electronics, pharmaceutical and food areas which require high-pressure carbon dioxide. For example, in the electronics industry, high-pressure carbon dioxide (e.g., at pressures of 3000 psig or 207 bar or higher) can be used in wafer processing techniques such as stripping of photoresist, formation of micro and nano-particles or structures and layer depositions. In the pharmaceutical industry, researchers are investigating the use of supercritical carbon dioxide to formulate nano-drug particles. In food applications, carbon dioxide is used, for example, in beverage carbonation.

These applications require a continuous supply of large quantities of substantially pure, high-pressure carbon dioxide fluid flows that can be delivered to a process area or end-point in a safe and cost-effective manner. Since carbon dioxide is typically not consumed in many of these processes, it is also desirable to recycle the used carbon dioxide for economic as well as environmental reasons.

In pressurized carbon dioxide delivery systems, liquid carbon dioxide is typically pressurized within or proximate the storage vessel, and the high pressure carbon dioxide is then delivered to the point of use via piping which can withstand high pressures. For example, liquid carbon dioxide is typically stored at low pressures (e.g., about 300 psig (about 20.7 bar) or less) in one or more storage tanks or vessels. The storage vessels can be physically located at large distances (e.g., 50 meters or more) from the process area or usage point, such that a low pressure pump is often necessary to transport the carbon dioxide from the storage vessels to the process area via suitable piping.

Many emerging applications in the semiconductor industry require high-purity, high-pressure carbon dioxide (CO₂) at the point-of-use (e.g., in a process tool) that is substantially free of impurities. For electronics applications, the process area must be very clean and is typically provided in a fabrication or processing room. For example, a process tool to remove photoresist from a wafer surface using high-pressure CO₂ typically is situated in a clean room to prevent exposure to impurities or contaminants of the process tool and wafers processed by the tool. A “class 100” clean room is an exemplary room for processing a semiconductor wafer in which photoresist is removed from the wafer. Such a clean room is designed to maintain less than one hundred particles at sizes larger than 0.5 micron per cubic foot of air space. Equipment associated with high-pressure carbon dioxide delivery systems, such as CO₂ storage tanks, pressurization pumps, heat exchangers, etc. must be kept outside the clean room so as minimize the dimensional requirements of the clean room and to facilitate ease of service of the delivery system components.

In many cases, the distance between the CO₂ storage tank and the process tool can be very large (e.g., on the order of one hundred meters or more). There are several challenges in transporting high-pressure CO₂ over large distances. For example, to maintain high purity levels of the carbon dioxide, special electropolished stainless steel piping is used to transport CO₂ streams, and this piping can be very expensive, particularly when designed to withstand the high-pressures required for the CO₂ streams. In addition, when high-pressure CO₂ streams are transported over large distances, there can be substantial pressure drops in the piping lines. Another important consideration is the safety risk associated with transferring high-pressure carbon dioxide over large distances, where any leak or rupture in the lines can result in the release of large quantities of carbon dioxide to the surrounding environment.

A further problem associated with transporting high-pressure carbon dioxide over large distances is maintaining the temperature and pressure of the CO₂ stream within desired ranges. For example, in processing systems where CO₂ is used sporadically (i.e., not continuously), the CO₂ may become stagnant in the piping lines (e.g., during a period of non-use of a process tool). This in turn may lead to an increase in temperature of the CO₂ (due to the higher ambient temperatures surrounding the piping lines), which in turn may lead to increased pressures of CO₂ in the piping supply lines. Depending upon the increase in temperature, carbon dioxide vaporization may occur, leading to subsequent problems such as the inability of carbon dioxide pumps to pressurize the vapor-liquid mixture because of cavitation in the pump.

### SUMMARY OF THE INVENTION

It is an object of the present invention to supply fluids, such as CO₂, to a process site requiring use of the fluids at high pressures, where the fluids are delivered from a supply source over long distances (e.g., 50 meters or more) while maintaining desired temperature and pressure conditions of the fluids during delivery and at the process site.

It is another object of the present invention to supply such fluids to the process site at desired temperature and pressure conditions while maintaining a sufficient purity level of the fluids.

It is a further object to recover at least a portion of the fluids from the process site after use of the fluids in a processing application.

The aforesaid objects are achieved individually and/or in combination, and it is not intended that the present invention be construed as requiring two or more of the objects to be combined unless expressly required by the claims attached hereto.

In accordance with the present invention, a purification and delivery system that delivers a high-pressure fluid to a process area comprises a fluid supply tank with a fluid in a liquid state, a purification section including at least one purification unit to remove at least one component from the fluid, and a high-pressure pump disposed downstream from the fluid supply tank and proximate the process area. The high-pressure pump pressurizes the fluid to a process pressure that is greater than the pressure of the fluid within the fluid supply tank.

In another embodiment of the present invention, a method of purifying and delivering a high-pressure fluid to a process area comprises providing fluid in a liquid state from a fluid supply tank for delivery to the process area, removing at least one component from the fluid via at least one purification unit of the purification section, and pressurizing fluid flowing from the fluid supply tank to a process pressure, via a high-pressure pump disposed at a location proximate the process area. The process pressure is greater than the pressure of fluid within the fluid supply tank. The method further comprises delivering the fluid at the process pressure to the process area.

By providing the high-pressure pump proximate the process area in accordance with the invention, the distance at which high-pressure fluid must be transported while maintaining required operating temperatures and pressures is minimized.

The above and still further objects, features and advantages of the present invention will become apparent upon consideration of the following detailed description of specific embodiments thereof, particularly when taken in conjunction with the accompanying drawings wherein like reference numerals in the figures are utilized to designate like components.

### BRIEF DESCRIPTION OF THE DRAWINGS

FIG. 1 is a diagram of an exemplary embodiment of a high-pressure fluid supply, purification and recovery system in accordance with the present invention.

FIG. 2 is a diagram of a portion of a modified embodiment of the system of FIG. 1 employing multiple process chambers within the system, with all of the process chambers receiving fluid from a single high-pressure pump and purification section in accordance with the present invention.

FIG. 3 is a diagram of a portion of another modified embodiment of the system of FIG. 1, in which multiple process chambers are employed, each with its own respective high-pressure pump and purification section in accordance with the present invention.

FIG. 4 is a diagram of a portion of a further modified embodiment of the system of FIG. 1, including a pump installed between the secondary tanks and the primary tank in accordance with the present invention.

FIG. 5 is a diagram of a portion of still another modified embodiment of the system of FIG. 1, in which one of the secondary tanks includes a purification section with controlled feedback in accordance with the present invention.

### DESCRIPTION OF PREFERRED EMBODIMENTS

In accordance with the present invention, purification and delivery of high-pressure fluids is achieved by providing the fluids from a supply source located at a site remote from a processing site, selectively purifying the fluids during transport, and pressurizing the fluids proximate the processing site prior to delivery to the process site.

Preferably, a two-stage pressurization of the fluid is provided, where the fluid is stored at the remote supply source, purified and transported at least a portion of the distance to the supply site at one or more pressures that are below the required processing pressure for the fluid. The fluid is pressurized to the desired high-pressure immediately upstream from the process site.

Other features of the invention include recycling of the fluids after use at the process site, and by-pass features as described below that maintain the temperature and pressure conditions of the fluids within desired ranges during periods in which the fluids are not being delivered to the process site. Fluids can be delivered in accordance with the invention at the desired temperature and high-pressure ranges for both batch and continuous processes.

In the embodiments described below, carbon dioxide (CO₂) is purified and pressurized to a selected high-pressure prior to delivery to a process site. However, the invention is not limited to processing carbon dioxide, and can include any one or combination of fluids for processing including, without limitation, oxygen, carbon dioxide, nitrogen, water, ammonia, and selected alkyls. The levels to which the fluids are to be pressurized can vary depending upon a particular application. When utilizing CO₂ for semiconductor processing applications, for example, the CO₂ fluids can be pressurized to high pressures in the range of about 3000 psig (about 207 bar) to about 8000 psig (about 552 bar).

In systems where carbon dioxide is to be delivered to a process site or area, the process area could be, for example, a tool utilized in an integrated circuit manufacturing step in the semiconductor industry. The integrated manufacturing step may include, for example, wafer cleaning, where photoresist or residue is stripped or removed from a silicon wafer using high-pressure carbon dioxide. Another example in which high-pressure carbon dioxide is used is in healthcare or pharmaceutical industries, where high-pressure carbon dioxide can be used to make certain compounds or for sterilization purposes. Still another example in which high-pressure carbon dioxide is used is in the food preparation industry (e.g., for carbonation of beverages). The systems and methods of the invention, as described below, can be utilized to deliver purified, high-pressure carbon dioxide to any selected process area.

As noted above, the invention preferably employs a two-stage pressurization for the carbon dioxide, where carbon dioxide is first pressurized remotely to a low pressure at or proximate the CO₂ supply source (e.g., a storage tank or vessel). Exemplary low pressures are in to the range of about 300 psig (about 21 bar) to about 1800 psig (about 124 bar). The low-pressure carbon dioxide is then sent to the process site or area where it is then pressurized further using a secondary or high-pressure pump. Preferably, the secondary pump is situated proximate or immediately upstream in relation to the process area or tool. In semiconductor applications, in which the process area is a clean room as described above, the secondary pump can be situated just outside of the clean room (e.g., in a sub-fab area as described below).

Alternatively, in certain embodiments of the invention, a two-stage pressurization may not be required. In these embodiments, the CO₂ tank is at a sufficient pressure to deliver CO₂ streams to the high-pressure pump for pressurization to the desired pressures prior to being sent to the process site.

A recirculation loop can be provided between the CO₂ supply source and the process site to maintain the temperature and pressure conditions of the CO₂ stream within desired ranges in the event ambient conditions around the transport lines fluctuate and/or the process area is not operational. For example, the recirculation loop prevents the CO₂ stream from becoming stagnant in the transport piping lines during periods in which the process site is shut down or brought off-line.

In other embodiments of the invention, multiple storage tanks can be provided to facilitate an uninterrupted supply of CO₂ (e.g., switching between storage tanks when one tank becomes depleted). For example, a system may include a main tank to supply CO₂ to the process site, and one or more secondary tanks to store CO₂ that has been processed and recycled from the process site, where the secondary tanks optionally purify and feed the CO₂ to the main tank for reuse at the process site.

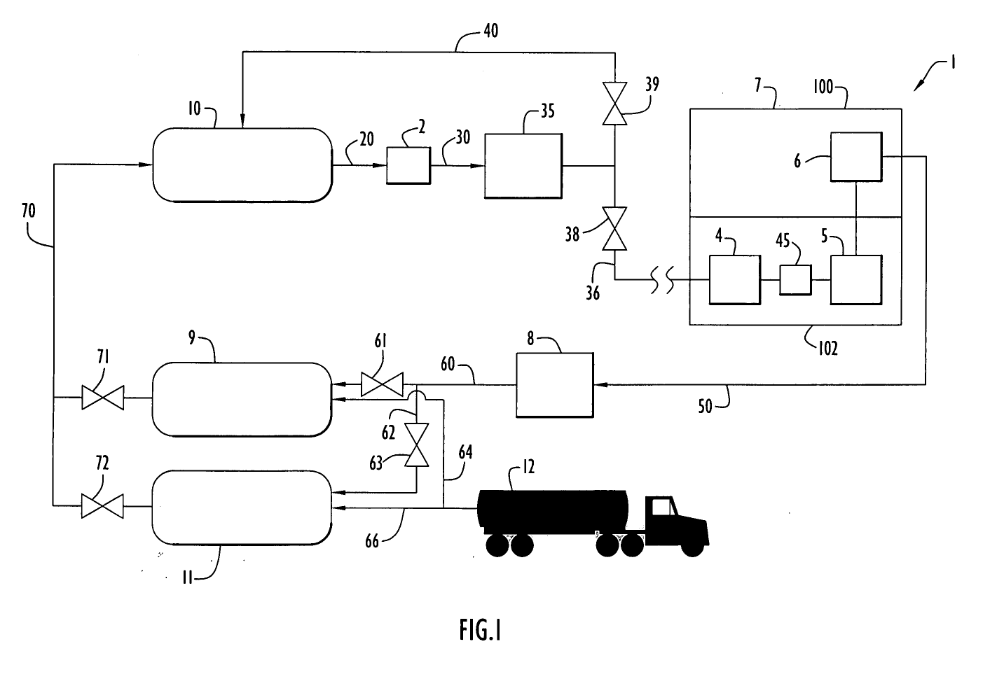

An exemplary embodiment of a two-stage pressurization system for supplying purified and high-pressure CO₂ to a semiconductor process chamber in accordance with the invention is depicted in FIG. 1. System 1 includes a primary storage tank 10 that supplies CO₂ for the system. The primary storage tank stores liquid CO₂ at suitable conditions, for example, at a temperature of about −5° F. (about −20° C.) and a pressure ranging from about 300 psig (about 21 bar) to about 350 psig (about 24 bar). Primary storage tank 10 is connected to a first pump 2 via a supply line 20 to facilitate delivery of liquid CO₂ to the pump. Primary storage tank 10 and pump 2 are located remotely from a process area 7 but are preferably in close proximity with each other. For example, the primary storage tank can be situated at distances from about 50 meters to about 1 kilometer or more from the process area. Preferably, the primary storage tank is situated at least about 100 meters from the process area.

Pump 2 pressurizes the liquid CO₂ and then delivers the pressurized CO₂ to a purification section 35 via a supply line 30. Preferably, pump 2 pressurizes the CO₂ to a pressure in the range of about 300 psig (about 21 bar) to about 1800 psig (124 bar), preferably in the range of about 300 psig (about 21 bar) to about 1200 psig (about 83 bar), prior to delivery to the purification section. The temperature conditions of the CO₂ stream are also maintained in the supply lines and corresponding equipment (e.g., via suitable insulating materials), such that the carbon dioxide is maintained below its critical temperature and above its vapor pressure at the process temperatures, thus ensuring the CO₂ stream remains in a liquid state during transport to the process area. In system designs where the storage tank is relatively close to the process area (e.g., within about 100 meters of the process area), and depending upon the CO₂ pressure within the primary tank, the fluid pressure within the tank may be sufficient to deliver the CO₂ stream to the process area so as to eliminate the need for pump 2.

A purification section is optionally provided within system 1 to remove impurities within the CO₂ stream prior to delivery to the process area. The number and types of different purification units that are provided in purification section 35 will depend upon the amount and/or types of impurities that may be present in the CO₂ stream being delivered from tank 10. In particular, the purification section may include any suitable number and types of purification units to remove any number of different types of impurities that may exist in the CO₂ stream. Exemplary purification units that may be provided in the purification section include, without limitation, adsorption units (e.g., pressure swing adsorption units, vacuum swing adsorption units, thermal swing adsorption units, etc.), absorber units, distillation units, filtration units (e.g., one or more filters with selected mesh sizes), catalytic oxidation units, coalescer units and mechanical separators (e.g., cyclonic separators).

Further, two or more purification sections may be provided in the system between the storage tank and the process area, and any suitable configuration of purification sections and purification units may be employed. Exemplary purification section configurations that may be provided in the system of the present invention include, without limitation, purification sections as described in U.S. patent application Ser. No. 10/860,599, the disclosure of which is incorporated herein by reference in its entirety. The CO₂ stream can be purified so as to be substantially free of impurities (e.g., containing at least about 99.99% by volume of CO₂). Further, it is noted that the purification can consist of a filtration unit (e.g., a single filter) for filtering particulate materials of selected sizes from the CO₂ stream.

The purification section or sections may be disposed proximate the primary tank and/or proximate the process area. In certain applications, a simple filtration system may be sufficient to obtain a CO₂ stream at the desired purity level. In such applications, the filtration system is preferably situated proximate the process area.

Purification section 35 is connected with process area 7 via a supply line 36. A valve 38 is disposed along supply line 36 and is selectively adjustable to control the flow of the CO₂ stream to the process area. A recirculation line 40 is connected between supply line 36 (at a location upstream from valve 38) and primary storage tank 10 to facilitate selective recirculation of the CO₂ stream back to the primary storage tank. A valve 39 is disposed along recirculation line 40 so as to facilitate selective control of the amount of CO₂ fluid recirculating to the storage tank during system operation. Valves 38 and 39 can be controlled manually or automatically (via a suitable controller) based upon the temperature and pressure conditions of the CO₂ stream within supply line 36. In addition, suitable temperature and/or pressure sensors can be provided at one or more suitable locations to measure the conditions of the CO₂ stream within supply line 36 and/or at other locations in system 1 so as to provide feedback control for selective adjustment of valves 38 and 39 during system operation.

The recirculation loop maintains the temperature and pressure conditions of the CO₂ stream by selectively diverting some or all of the carbon dioxide back to tank 10 when processing within process area 7 is shut down and/or due to temperature fluctuations of the ambient surroundings. For example, in situations where there is no carbon dioxide flow to the process area for several hours, the carbon dioxide in the supply lines can become stagnant if there is no recirculation loop, which can in turn result in an increase in temperature if the ambient temperature is higher than the liquid CO₂ temperature. Even in systems where the supply lines are insulated, there can be some temperature increase and formation of vapor-liquid phase mixtures. The increase in temperature can result in substantial increases in line pressures due to vaporization of the CO₂ stream. The recirculation loop provided in system 1 ensures that the CO₂ stream remains in the liquid state and at desired temperature and pressure conditions.

Process area 7 includes a process tool 6 disposed in a clean room 100. The process tool can be, e.g., a tool that utilizes supercritical carbon dioxide to remove photoresist from and/or process a semiconductor wafer in any other suitable manner. The CO₂ processing pressure in the tool can be in the range of about 3000 psig (about 207 bar) to about 8000 psig (about 552 bar). A high-pressure pump 4 is situated in close proximity to process tool 6 and increases the pressure of the liquid CO₂ stream to the required processing pressure for the tool (e.g., to the previously noted pressures). The high-pressure pump is preferably situated as close to the process tool as possible while preferably being outside of the clean room (e.g., within about 50 meters of the process tool). As noted above, the process tool for semiconductor processes often must be kept in a substantially clean environment that is separated from other process equipment. Preferably, high-pressure pump 4 is provided in an enclosed space 102 partitioned from and disposed beneath the clean room, typically referred to as the sub-fab area. When disposed within the sub-fab area, it is possible to provide the high-pressure pump at a very close distance from the process tool while keeping the pump outside of the clean room. For example, in the configuration as set forth in FIG. 1, the pump can be located within about 10 meters of the process tool, preferably within about 5 meters of the process tool.

The high-pressure pump is of a suitable type to minimize any addition of impurities in the CO₂ stream. For example, the high-pressure pump is preferably a diaphragm pump or any other pump of similar design that minimizes direct contact between the CO₂ fluid and any moving parts in the pump. Optionally, in applications where it is desirable to further purify the CO₂ stream after pressurization, a second purification section 45 is also provided in sub-fab area 102 directly downstream from high-pressure pump 4. For example, the second purification section can include a filter to remove particulate material that may have been introduced into the pressurized CO₂ stream from pump 4. Alternatively, any number of purification units as described above can be provided in the second purification section.

A conditioning module 5 is provided sub-fab area 102 at a location downstream from second purification section 45. The conditioning module can be any suitable device (e.g., heat exchanger or other heating and/or cooling unit) that adjusts the temperature of the high-pressure CO₂ stream, while preferably maintaining the CO₂ stream in liquid state, prior to delivery to process tool 6 in clean room 100. Preferably, the conditioning module thermally treats the CO₂ stream such that the stream is within a temperature range of about 15° C. to about 200° C., more preferably in the range of about 35° C. to about 100° C., prior to delivery to the process tool.

Optionally, any suitable additives (e.g., co-solvents and/or surfactants) can be added in the high-pressure CO₂ stream at any suitable location along the supply line and preferably within the sub-fab area (e.g., upstream or downstream from the conditioning module). For example, additives such as alcohols, halogenated hydrocarbons, saturated hydrocarbons, unsaturated hydrocarbons, aromatic hydrocarbons, amines, aldehydes, anhydrides, organic acids, inorganic acids, ketones, esters, glycols, fluoride containing materials and combinations thereof, can be added in the high-pressure CO₂ stream in the sub-fab area.

A third purification section 8 is provided downstream from process area 7 and is connected with process tool 6, via a supply line 50, to receive the CO₂ stream emerging from the process tool. Optionally, the pressure of the CO₂ stream is reduced to a selected pressure range (e.g., upon emerging from the process tool and/or at any other suitable area within the process area) prior to delivery to the third purification section. The third purification section can include any suitable combination of purification units as described above for the first and second purification units so as to remove impurities and additives from the CO₂ stream prior to recycling for reuse by the process tool. In an exemplary embodiment, the third purification section includes only a filter for filtering particulate materials of selected sizes from the CO₂ stream prior to delivery of the stream to the process tool.

The third purification section can deliver the purified CO₂ stream directly to primary storage tank 10 or, alternatively, to one or more secondary storage tanks that serve as back-up tanks for the primary storage tank. Referring to FIG. 1, system 1 includes secondary storage tanks 9 and 11 that are connected in parallel between third purification section 8 and primary storage tank 10. In particular, secondary storage tank 9 is connected to purification unit 8 via a supply line 60, with a valve 61 being disposed along line 60 to selectively control the flow of CO₂ fluid to tank 9. A supply line 62 branches from supply line 60 at a location upstream from valve 61 and connects with another secondary storage tank 11. A valve 63 is disposed along line 62 to selectively control the flow of CO₂ fluid to tank 11.

Each of secondary storage tanks 9 and 11 connect with primary storage tank 10 via a supply line 70, where each tank 9, 11 includes a respective valve 71, 72 at its outlet end to selectively control the flow of CO₂ fluid from the tanks to the primary storage tank. Carbon dioxide within tanks 9 and 11 is preferably maintained at temperature and pressure conditions that are similar to the conditions in the primary storage tank. Further, valves 61, 63, 71 and 72 can be manually or automatically controlled (e.g., via a suitable controller), with appropriate fluid level sensors and/or temperature and pressure sensors being provided in the primary and secondary tanks, to facilitate supply of CO₂ from either or both secondary tanks as necessary to the primary storage tank.

Each of secondary tanks 9 and 11 is further connected via supply lines 64 and 66 to an external liquid CO₂ stream supply source 12 (e.g., a tanker as depicted in FIG. 1 or, alternatively, an on-site CO₂ generation plant). The external CO₂ supply source provides make-up CO₂ to the secondary storage tanks to account for processing losses and thus ensure an adequate supply of liquid CO₂ is available at all times during system operation. An internal pressurizing device (e.g., pressure-building coils) can be provided in any or all of tanks 9, 10 and 11 to selectively increase and maintain the pressure of CO₂ fluid within the tanks as well as transfer of CO₂ fluid at selective flow rates between the tanks.

In operation, liquid CO₂ is stored in primary storage tank 10 at selected temperature and pressure conditions (e.g., a temperature of about −5° F. (about −20° C.) and a pressure ranging from about 300 psig (about 21 bar) to about 350 psig (about 24 bar)). The liquid CO₂ is delivered from tank 10 to pump 2, where the liquid CO₂ stream is first pressurized to a suitable pressure (e.g., in the range of about 300 psig (about 21 bar) to about 1800 psig (124 bar), preferably in the range of about 300 psig (about 21 bar) to about 1200 psig (about 83 bar)), prior to delivery to purification section 35. The liquid CO₂ stream is purified within purification section 35 and then delivered to process area 7 at the selected purity level. Depending upon the temperature and pressure conditions of the CO₂ stream within supply line 36 and whether process tool 6 is in operation or shut down, a portion (e.g., some or all) of the CO₂ stream is selectively diverted back to tank 10, via recirculation line 40 and selective manipulation of valves 38 and 39, to ensure the CO₂ stream is maintained as a liquid and at the desired temperature and pressure conditions.

The CO₂ stream emerging from purification section 35 is then directed into sub-fab area 102, where the C02 is further pressurized by high-pressure pump 4 to the required processing pressure (e.g., in the range of about 3000 psig (about 207 bar) to about 8000 psig (about 552 bar)), optionally purified in second purification section 45, and adjusted to the required temperature conditions within conditioner 5. The CO₂ stream is then directed into process tool 6 in clean room 100, where it is utilized to process a semiconductor wafer. After a processing operation is complete, the CO₂ stream emerges from the process tool and is recycled, via line 50, to third purification unit 8 for removal of impurities and/or additives from the CO₂ stream. The CO₂ stream is then directed to one or both of secondary storage tanks 9 and 11, where the CO₂ is stored at suitable temperature and pressure conditions (e.g., conditions similar to those described above for tank 10) prior to delivery back to primary storage tank 10. Liquid carbon dioxide is replenished as necessary to tanks 9 and 11 via the external CO₂ supply source 12 so as to maintain an adequate supply of CO₂ through operation of the process tool.

Thus, system 1 facilitates a continuous supply of high-pressure CO₂ to the process area at the desired purity levels while ensuring the CO₂ stream is maintained in a liquid state and at the desired temperature and pressure conditions throughout all areas of the system. The CO₂ storage tanks can be situated remotely (e.g., 50 meters or more, preferably 100 meters or more, and more preferably 1 kilometer or more) from the process area, and the CO₂ stream can be maintained in liquid state and at the desired temperatures and pressures despite ambient temperature fluctuations and/or halting of CO₂ supply to the process tool. Further, the transport of high-pressure CO₂ (e.g., at pressures in the range of about 3000 psig (about 207 bar) to about 8000 psig (about 552 bar)) is minimized or substantially reduced to the relatively short distance between the high-pressure pump and the process tool.

While the system described above and depicted in FIG. 1 shows a number of purification sections disposed at different locations within the system, the system is in no way limited to this configuration and can be modified to include a single purification section disposed between the high-pressure pump and the process tool (i.e., as indicated by purification section 45 in FIG. 1). The purification section can be as simple as a filtration unit (e.g., a single filter) to remove particulate material from the CO₂ stream prior to delivery of the stream to the process tool.

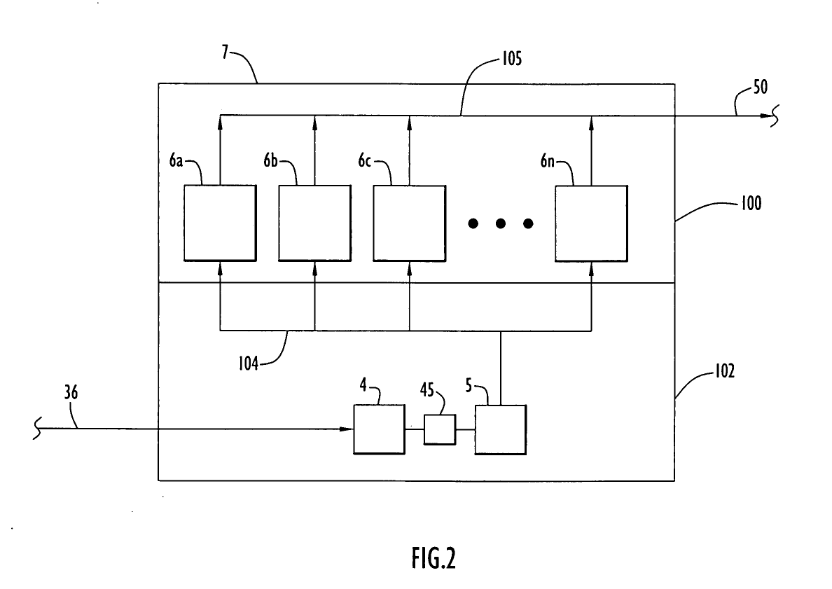

In another modification to the embodiment of FIG. 1, system 1 can be designed to provide CO₂ at the required pressure and temperature conditions to any selected number of process tools 6. For example, in the embodiment of FIG. 2, process area 7 is modified to include a series of process tools 6a to 6n that are each connected at their inlets via a suitable manifold piping system 104 to the main CO₂ supply from conditioner 5. The manifold piping system 104 can include a series of valves (not shown) along the branch lines to the inlets of the process tools 6 so as to selectively control the flow of CO₂ to each process tool. The process tools are further connected at their outlets via a suitable manifold piping system 105 to supply line 50 (which delivers the CO₂ to third purification unit 8). In this embodiment, the process area includes each process tool, and a single high-pressure pump is utilized to provide the CO₂ to multiple process tools.

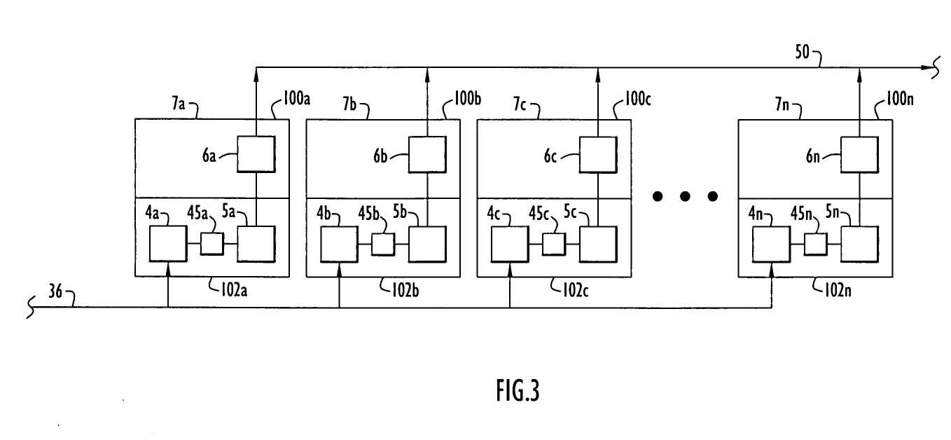

Alternatively, the system of FIG. 1 can be modified to include a selected number of process areas, where each process tool is connected with a separate high-pressure pump. Referring to FIG. 3, system 1 is modified to include a selected number of process areas 7a through 7n, where each process area 7 is substantially similar in configuration as the process area described above and depicted in FIG. 1. In particular, each process area 7a, . . .7n includes a process tool 6a, . . . 6n disposed in a clean room 100a, . . . 100n, and a sub-fab area 102a, . . . 102n that includes a high-pressure pump 4a, . . . 4n, purification section 45a, . . . 45n and conditioner 5a, . . . 5n. The process areas are connected in parallel at their inlet sections to supply line 36 via a manifold configuration, and are further connected at their outlet sections to supply line 50 via a manifold connection, such that the CO₂ streams emerging from the process tools are combined for recycling in line 50. The branch lines in each manifold section can include valves (not shown) to selectively control the flow of CO₂ fluid to each supply area.

Thus, the process area design of FIG. 3 enables each process tool to have its own dedicated pressurization, purification, and conditioning of CO₂ fluid. This design is particularly useful in applications in which two or more process tools are remote in distance from each other and therefore avoids the transport of high-pressure CO₂ over large distances (i.e., since the high-pressurization occurs individually proximate each process tool). This design is also useful in applications where two or more process tools are operating under different processing conditions at the same time. For example, one process tool may be in a loading stage (i.e., where a wafer is being loaded into the chamber) while another process tool is processing a wafer with high-pressure CO₂, and further still while another process tool is in a depressurization or reducing pressure stage (e.g., immediately following wafer processing).

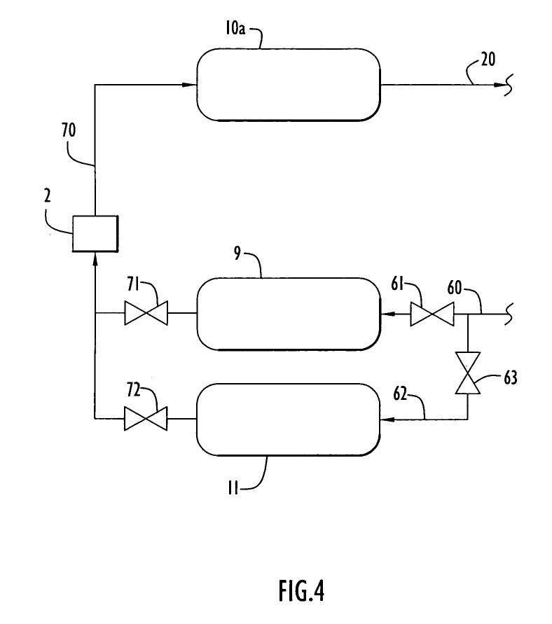

Still another modification to the system of FIG. 1 is depicted in FIG. 4. In this embodiment, the primary storage tank is maintained at a higher pressure than in the previous embodiments, such that liquid carbon dioxide can be directly transported to purification section 35 without the use of a pump. In particular, primary storage tank 10a is a high-pressure storage tank that is initially filled with liquid CO₂ at cryogenic conditions. The temperature of the CO₂ can be allowed to increase within the primary storage tank to facilitate an increase in pressure within the tank. For example, the temperature of CO₂ may be allowed to increase to ambient temperature (e.g., about 68° F. or about 20° C.), resulting in a corresponding increase in pressure (e.g., about 840 psig or about 58 bar, which is the vapor pressure of CO₂ at the ambient temperature described above). The advantage of this embodiment is that the CO₂ in the primary storage tank is pressurized without the requirement of additional and externally applied mechanical or thermal energies. Thus, the CO₂ stream from tank 10a can be transported via supply line 20 directly to purification unit 35.

A pump 2 is optionally provided along supply line 70 between secondary storage tanks 9 and 11 and primary storage tank 10a to facilitate transfer of CO₂ fluids from the secondary tanks to the primary tank. In addition, pump 2 can be used to increase the pressure in tank 10a above the vapor pressure for CO₂ at the ambient temperature. Alternatively, as noted above, the secondary storage tanks can include internal heating coils to heat and pressurize the CO₂ fluid as necessary to facilitate flow of CO₂ from the secondary storage tanks to the primary storage tank. The pressure in the primary storage tank can be adjusted depending upon the distance between tank 10a and process area 7 (e.g., larger distances and/or increased flow rates of the CO₂ stream may require an increased pressure within tank 10a). Exemplary pressures of CO₂ within tank 10a are the range of about 300 psig (about 21 bar) to about 1500 psig (about 103 bar), and preferably in the range of about 700 psig (about 48 bar) to about 1200 psig (about 83 bar).

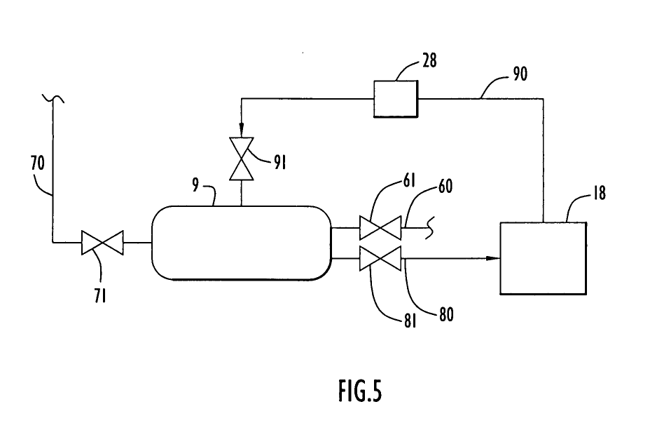

In yet another modification of the system described above, one or more of the secondary storage tanks can be directly connected with purification sections to facilitate additional purification of CO₂ within the storage tanks prior to delivery to the primary storage tank. Referring to FIG. 5, secondary storage tank 9 is further connected to a purification section 18 via a supply line 80, where a valve 81 is disposed along line 80. The purification section can include any one or more of the previously described purification units to facilitate removal of impurities from the CO₂ being stored in tank 9.

A recycle line 90 extends between purification section 18 and tank 9, with a valve 91 disposed along line 90, to facilitate recirculation of CO₂ fluids between the tank and the purification unit(s). In addition, an analyzer module 28 is provided in-line along recycle line 90. The analyzer module includes any suitable number and types of analyzers to continuously measure the concentrations of impurities in the CO₂ stream passing through line 90. The valves 81 and 91 may be manually or automatically controlled (e.g., via a suitable controller) to facilitate flow of CO₂ to the purification section based upon feedback information provided by the analyzer module regarding impurity concentrations in the CO₂ stream. Thus, the closed loop recirculation and purification design of FIG. 5 facilitates the purification of the CO₂ stream until a selected purity level is reached. Upon achieving the desired purity level, the CO₂ can be delivered to the primary storage tank and/or any other secondary storage tanks of the system.

The system of FIG. 5 allows the impurity levels of the stored liquid carbon dioxide to be reduced to extremely low levels, preferably on the order of less than 1 part per million (ppm), more preferably in the range of parts per billion (ppb), and most preferably in the range of parts per trillion (ppt). Such purity levels are required for certain processing applications.

In an exemplary embodiment of the system of FIG. 5, the purification section 8 includes a catalytic oxidation unit that removes hydrocarbon based impurities, where hydrocarbon impurities are oxidized to simpler molecules (e.g., H₂O and CO₂) in presence of an oxidant (e.g., O₂) and a catalyst. The in-line analyzer module 28 includes hydrocarbon and oxygen analyzers. The hydrocarbon analyzer measures the concentrations of selected hydrocarbons in the CO₂ stream emerging from purification section 18. If the hydrocarbon concentration is determined to be above an acceptable level, oxygen is injected into the catalytic oxidation unit via an injection line (not shown). The CO₂ stream emerging from the oxidation unit is also analyzed for oxygen concentration. If the O₂ concentration exceeds a threshold level, the amount of oxygen injected into the oxidation unit is decreased. The recirculation of the CO₂ stream via line 90 is carried out until the measured hydrocarbon concentration levels within the CO₂ is within acceptable levels. Purification section 18 can include additional purification units, such as an adsorption unit to remove reaction byproducts like water to acceptable levels.

The secondary tank configuration of FIG. 5 can also be provided proximate the process area to purify and recycle the CO₂ stream emerging from the process tool. In particular, a secondary storage tank 9, as depicted in FIG. 5, can be situated proximate (e.g., within about 100 meters) of the process area to receive a selected portion (e.g., about 80% by volume) of the CO₂ stream emerging from the process tool, where the CO₂ stream is purified via purification section 18 to a selected purity level prior to delivery to the high-pressure pump for re-use by the process tool. The remainder (e.g., about 20%) of the CO₂ stream emerging from the process tool is directed to the primary storage tank in the manner described above and depicted in FIG. 1.

As noted above, the systems described above are not limited to use with semiconductor process chambers. Rather, the systems can be implemented for use with any number of different process stations in which carbon dioxide or other fluids are utilized for cleaning or any other process, where the fluids are preferably maintained in liquid state prior to being pressurized by the high-pressure pump disposed proximate the process area.

Having described novel systems and method for purification and delivery of high-pressure fluids in processing applications, it is believed that other modifications, variations and changes will be suggested to those skilled in the art in view of the teachings set forth herein. It is therefore to be understood that all such variations, modifications and changes are believed to fall within the scope of the present invention as defined by the appended claims.

1. A purification and delivery system to deliver a high-pressure fluid to a process area, the system comprising:
a fluid supply tank including a fluid in a liquid state;
a purification section including at least one purification unit to remove at least one component from the fluid flowing through the purification section; and
a high-pressure pump disposed downstream from the fluid supply tank and proximate the process area, wherein the high-pressure pump pressurizes the fluid to a process pressure that is greater than the pressure of the fluid within the fluid supply tank.

2. The system of claim 1, further comprising:
a pump disposed downstream from the fluid supply tank, wherein the pump pressurizes fluid received from the fluid supply tank to a pressure that is greater than the pressure of fluid within the fluid supply tank and less than the process pressure.

3. The system of claim 1, wherein the fluid comprises carbon dioxide.

4. The system of claim 3, wherein the high-pressure pump is configured to pressurize the carbon dioxide to a pressure of at least about 207 bar.

5. The system of claim 1, wherein the process area includes a process tool, and the high-pressure pump is located within about fifty meters of the process tool.

6. The system of claim 5, wherein the fluid supply tank is located at least about 100 meters from the process area.

7. The system of claim 4, wherein the high-pressure pump is disposed within an area located beneath the process area.

8. The system of claim 1, further comprising:
a recirculation line disposed between the fluid supply tank and the high-pressure pump to facilitate selective recycling of fluid back to the fluid supply tank without being delivered to the high-pressure pump.

9. The system of claim 1, further comprising:
a recirculation line configured to deliver fluid exiting the process area to at least the high-pressure pump.

10. The system of claim 9, further comprising:
at least one secondary fluid supply tank configured to receive and store fluid flowing within the recirculation line.

11. The system of claim 10, wherein:
the at least one secondary fluid supply tank is further connected with the fluid supply tank to deliver fluid stored within the at least one secondary fluid supply tank to the fluid supply tank; and
the purification section is disposed between the process area and the at least one secondary fluid supply tank.

12. The system of claim 10, wherein the purification section is connected with the at least one secondary fluid supply tank, and the system further comprises:
a second recirculation line to facilitate recirculation of fluid between the purification section and the at least one secondary fluid supply tank.

13. The system of claim 12, further comprising:
an analyzer disposed along the second recirculation line between the purification section and the at least one secondary purification section, wherein the analyzer measures a concentration of the at least one component within the fluid flowing through the analyzer.

14. The system of claim 10, further comprising:
a pump connected between the at least one secondary fluid supply tank and the fluid supply tank.

15. The system of claim 1, wherein the purification section is disposed between the high-pressure pump and the process area.

16. The system of claim 1, wherein the at least one purification unit includes a filter.

17. The system of claim 1, further comprising:
a conditioning module disposed between the high-pressure pump and the process area and configured to thermally treat fluid flowing through the conditioning module to a selected temperature prior to delivery of the fluid to the process area.

18. The system of claim 1, wherein the purification section is disposed between the fluid supply tank and the high-pressure pump, and the system further comprises:
a second purification section disposed between the high-pressure pump and the process area, wherein the second purification section includes at least one purification unit to remove at least one component from the fluid flowing through the second purification section.

19. The system of claim 1, wherein the process area comprises a plurality of process tools that receive fluid from the high-pressure pump at the process pressure.

20. The system of claim 1, wherein the system delivers high-pressure fluid to a plurality of process areas, and the system further comprises:
a plurality of high-pressure pumps disposed downstream from the fluid supply tank, wherein each high-pressure pump is located proximate a respective process area and pressurizes a selected portion of fluid provided by the fluid supply tank to a process pressure that is higher than the pressure of the fluid within the fluid supply tank for delivery to the respective process area.

21. A method of purifying and delivering a high-pressure fluid to a process area, the method comprising:
providing fluid in a liquid state from a fluid supply tank for delivery to the process area;
removing at least one component from the fluid flowing through a purification section via at least one purification unit of the purification section;
pressurizing fluid flowing from the fluid supply tank to a process pressure, via a high-pressure pump disposed at a location proximate the process area, wherein the process pressure is greater than the pressure of fluid within the fluid supply tank; and
delivering the fluid at the process pressure to the process area.

22. The method of claim 21, further comprising:
pressurizing fluid flowing from the fluid supply tank, via a pump disposed downstream from the fluid supply tank, to a pressure that is greater than the pressure of fluid within the fluid supply tank and less than the process pressure.

23. The method of claim 21, wherein the fluid comprises carbon dioxide.

24. The method of claim 23, wherein the process pressure is at least about 207 bar.

25. The method of claim 21, wherein the process area includes a process tool, and the high-pressure pump is located within about fifty meters of the process tool.

26. The method of claim 25, wherein the fluid supply tank is located at least about 100 meters from the process area.

27. The method of claim 25, wherein the high-pressure pump is disposed within an area located beneath the process area.

28. The method of claim 21, further comprising:
selectively recirculating at least a portion of fluid flowing from the fluid supply tank back to the fluid supply tank to prevent the recirculated fluid from flowing to the high-pressure pump and the process area.

29. The method of claim 21, further comprising:
recirculating fluid exiting the process area back to at least the high-pressure pump.

30. The method of claim 21, further comprising:
directing at least a portion of fluid flowing from the process area to at least one secondary fluid supply tank.

31. The method of claim 30, wherein the purification section is disposed between the process area and the at least one secondary fluid supply tank, and the method further comprises:
directing fluid from the at least one secondary fluid supply tank to the fluid supply tank.

32. The method of claim 30, wherein the purification section is connected with the at least one secondary storage tank, and the method further comprises:
selectively recirculating fluid between the at least one secondary fluid supply tank and the purification section.

33. The method of claim 32, further comprising:
measuring a concentration of the at least one component within the fluid flowing between the purification section and the at least one secondary fluid supply tank; and
selectively adjusting the flow of fluid between the purification section and the at least one secondary fluid supply tank based upon the measured concentration of the at least one component.

34. The method of claim 30, further comprising:
pressurizing fluid flowing from the at least one secondary fluid supply tank via a pump disposed between the at least one secondary fluid supply tank and the fluid supply tank; and
delivering fluid from the pump to the fluid supply tank.

35. The method of claim 21, wherein the purification section is disposed between the high-pressure pump and the process area, and the at least one component is removed from the fluid, via the at least one purification unit, at the process pressure.

36. The method of claim 35, wherein the at least one purification unit includes a filter.

37. The method of claim 21, further comprising:
providing fluid at the process pressure from the high-pressure pump to a conditioning module;
thermally treating the fluid, via the conditioning module, to a selected temperature; and
delivering the fluid at the process pressure and the selected temperature to the process area.

38. The method of claim 21, wherein the process area includes a plurality of process tools, and the high-pressure pump delivers fluid at the process pressure to the plurality of process tools.

39. The method of claim 21, wherein a plurality of high-pressure pumps are disposed proximate a plurality of process areas, and a selected portion of fluid provided by the fluid supply tank is pressurized by each high-pressure pump to a process pressure for delivery to a respective process area connected with each high-pressure pump.

40. The method of claim 21, wherein the purification section is disposed between the fluid supply tank and the high-pressure pump, and the method further comprises:
removing at least one component from the fluid flowing through a second purification section via at least one purification unit of the purification section, wherein the second purification section is disposed between the high-pressure pump and the process area.
